(19) United States
(12) Patent Application Publication
(10) Pub. No.: US 2011/0037960 A1
(43) Pub. Date: Feb. 17, 2011

(54) LITHOGRAPHIC APPARATUS, DEVICE MANUFACTURING METHOD, CLEANING SYSTEM AND METHOD FOR CLEANING A PATTERNING DEVICE

(75) Inventors: Luigi Scaccabarozzi, Valkenswaard (NL); Vladimir Vitalevich Ivanov, Moscow (RU); Konstantin Nikolaevich Koshelev, Troitsk (RU); Johannes Hubertus Josephina Moors, Helmond (NL); Lucas Henricus Johannes Stevens, Eindhoven (NL); Pavel Stanislavoich Antsiferov, Troitsk (RU); Vladimir Mihailovitch Krivtsun, Troitsk (RU); Leonid Alexandrovich Dorokhin, Troitsk (RU); Maarten Van Kampen, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 12/989,045

(22) PCT Filed: Apr. 16, 2009
(86) PCT No.: PCT/EP09/02782

§ 371 Date: Oct. 21, 2010

Related U.S. Application Data
(60) Provisional application No. 61/071,345, filed on Apr. 23, 2008.

(51) Int. Cl. G03B 27/52

(52) U.S. Cl. 355/30

(57) ABSTRACT

A lithographic apparatus includes an illumination system configured to condition a beam of radiation, and a support structure configured to support a patterning device. The patterning device is configured to impart a pattern to the beam of radiation. The apparatus includes a patterning device cleaning system configured to provide an electrostatic force to contaminant particles that are on the patterning device and that are electrically charged by the beam of radiation, in order to remove the contaminant particles from the patterning device.

### CROSS-REFERENCE TO RELATED APPLICATIONS

This application claims the benefit of U.S. provisional application 61/071,345, which was filed on 23 Apr. 2008, and which is incorporated'herein in its entirety by reference.

### FIELD

The present invention relates to a lithographic apparatus, a method for manufacturing a device, a cleaning system and a method for cleaning a patterning device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Within and around a lithographic apparatus, it is desirable to remove any contamination that may reduce the quality of the patterns formed. In particular, for example, it is desirable to ensure that the patterning device that is used to pattern a beam of radiation, which is projected onto a substrate, is to the extent possible, free of contaminant particles that may affect the image projected onto the substrate. It has previously been known to cover a patterning device with a pellicle, which is a transparent cover arranged above the surface that is provided with the pattern. This may facilitate cleaning of the patterning device without risk of damaging the patterned surface. In addition, any contaminant particles that remain on the pellicle surface do not lie within the plane of the patterning surface. Accordingly, such particles are not imaged onto the substrate in focus and their impact is reduced.

### SUMMARY

It is not always possible to provide a pellicle to a patterning device. For example, in lithography using EUV radiation, it is desirable to minimize the absorption of the EUV radiation by the optical components of the lithographic apparatus. Accordingly, it is desirable to avoid the use of transmissive optical elements, such as a pellicle that absorb EUV radiation. Consequently, a pellicle may not be provided and it may be desirable to provide a system for cleaning the patterned surface of a patterning device that is to pattern a EUV beam of radiation. This may pose significant challenges because the particles that are to be removed may be very small, for example, particles as small as 30 nm may need to be removed and the forces adhering the particles to the surface may be relatively large. Accordingly, considerable effort may be needed to remove the particles. However, extreme care should be taken to ensure that the patterned surface itself is not damaged in the process of removing the particles. Finally, it will be appreciated that lithographic apparatus operate in a commercial environment. Accordingly, it is desirable that the system for cleaning the patterning device does not greatly increase the cost of the lithographic system, either in terms of the capital cost of the system or in terms of the running costs of the system. The latter may be greatly increased if a considerable amount of time is used to clean the patterning device.

It is desirable to provide an improved cleaning system suitable for use in cleaning a patterning device in a lithographic apparatus.

According to an aspect of an embodiment of the invention, there is provided a lithographic apparatus includes an illumination system configured to condition a beam of radiation, and a support structure configured to support a patterning device. The patterning device is configured to impart a pattern to the beam of radiation. The apparatus includes a patterning device cleaning system configured to provide an electrostatic force to contaminant particles that are on the patterning device and that are electrically charged by the beam of radiation, in order to remove the contaminant particles from the patterning device.

According to an aspect of an embodiment of the invention, there is provided a device manufacturing method that includes patterning a beam of radiation using a patterning device, and removing contaminant particles from the patterning device by applying an electrostatic force to the contaminant particles that have been electrically charged by the beam of radiation.

According to an aspect of an embodiment of the invention, there is provided a cleaning system for a patterning device configured to impart a pattern to a beam of radiation. The cleaning system includes a support structure configured to support the patterning device, and a cleaning electrode configured to be located adjacent to the patterning device supported by the support structure. The cleaning system includes a voltage supply configured to establish a voltage difference between the cleaning electrode and a patterning device supported by the support structure such that contaminant particles on the patterning device are electrostatically repelled from the patterning device and/or electrostatically attracted to the cleaning electrode. The cleaning electrode is at least partially coated with an adhesive configured to adhere to contaminant particles that strike the cleaning electrode.

According to an aspect of an embodiment of the invention, there is provided a method for cleaning a patterning device configured to impart a pattern to a beam of radiation. The method includes arranging a cleaning electrode adjacent to the patterning device, and establishing a voltage difference between the cleaning electrode and the patterning device such that contaminant particles on the patterning device are electrostatically repelled from the patterning device and/or electrostatically attracted to the cleaning electrode. The cleaning electrode is at least partially coated with an adhesive configured to adhere to contaminant particles striking the cleaning electrode.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a cleaning system according to an embodiment of the present invention;

FIG. 3 depicts a cleaning system according to an embodiment of the present invention; and

FIG. 4 depicts a cleaning system according to an embodiment of the present invention.

### DETAILED DESCRIPTION

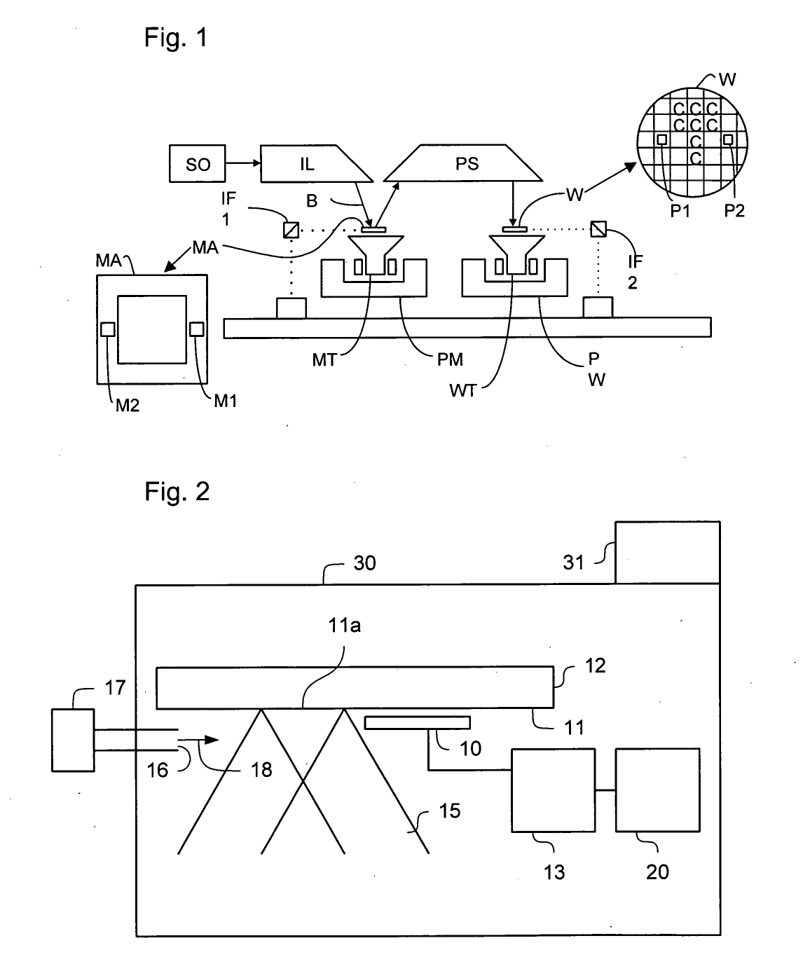

FIG. 1 schematically depicts a lithographic apparatus according to one embodiment of the invention. The apparatus comprises: an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The source SO and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Various new cleaning systems for cleaning patterning devices in lithographic apparatus have been considered. For example, it has been considered to use cleaning fluids in order to rinse particles from a patterning device. However, such cleaning systems may not be sufficiently effective at removing smaller particles. In addition, such cleaning systems may have been found to have problems with drying effects after the cleaning process has been completed and, finally, such cleaning systems may be relatively slow.

A new cleaning system that has been considered is to use ultrasonic vibration in order to remove particles from the patterning device. The ultrasonic vibration may be provided by vibrating the entire patterning device or by creating a surface acoustic wave. The latter option may create a higher velocity, making it easier to remove the particles from the surface.

A new cleaning system is proposed by embodiments of the present invention and uses an electrostatic force to remove particles from the surface of the patterning device. In a particular arrangement, shown in FIG. 4, a cleaning electrode 40 is brought close to a patterned surface 11 of a patterning device 12 and a high negative voltage pulse is established between the cleaning electrode 40 and the patterning device 12.

In order to establish the voltage difference between the cleaning electrode 40 and the patterning device 12, a voltage supply 41 may be connected to both components, as depicted in FIG. 4. Alternatively, for example, the patterning device 12 may be grounded and the voltage supply 41 may provide a voltage difference between the cleaning electrode 40 and ground.

The voltage supply 41 may establish a constant voltage difference between the cleaning electrode 40 and the patterning device 12. However, in a particular arrangement, pulses of voltage difference may be used in order to provide an electric charge to contaminant particles on the patterning device and create an electrostatic force that repels the contaminant particle from the patterned surface 11 of the patterning device 12 and/or attracts the contaminant particles to the cleaning electrode 40.

For example, a pulse of between approximately 0.5 kV and approximately 15 kV, or between approximately 5 kV and approximately 15 kV, for example approximately 10 kV, may be applied for a pulse having a duration of between approximately 1 μs and approximately 100 s or, in particular, between approximately 1 μs and approximately 10 μs. In such an arrangement, the electrode may be arranged adjacent to the patterned surface 11 of the patterning device 12, for example between approximately 0.01 μm and approximately 1 mm from the surface. In a particular arrangement, it may be between approximately 1 μm and 200 μm, for example approximately 100 μm, from the surface. In such an arrangement, the high voltage pulse both charges the particles on the substrate and generates a strong electric field, for example between approximately 10⁴V/cm, and approximately 2×10⁶V/cm, or approximately 10⁶V/cm at the surface, that draws the contaminant particles from the surface of the patterning device 12 towards the electrode. A larger electric field may also be used. In general, the size of the separation between the electrode and the surface to be cleaned may be limited by the size of the particles to be removed. In a possible arrangement, cleaning may be performed initially at a relatively large separation to remove the relatively large particles and then may be performed at a relatively small separation to remove smaller particles. It has been found that a cleaning system of this type may extract small particles from a surface. For example, it may extract particles of the order of 100 nm in size.

As depicted in FIG. 4, the cleaning electrode 40 may be at least partially coated with a layer of adhesive 43 or another coating suitable for use within the lithographic apparatus. An adhesive layer 43 may be configured such that contaminant particles that strike the electrode adhere to the cleaning electrode 40. Accordingly, such contaminant particles are subsequently retained on the cleaning electrode 40 regardless of changes in the voltage applied to the cleaning electrode. In addition, the coating layer may prevent arcing between the cleaning electrode 40 and the patterning device 12 which may result in damage to the patterning device 12. For example a dielectric coating layer may have a larger work function than the metal of the electrode. Furthermore, the coating layer may have a more smooth surface, resulting in a decrease of the local electric fields on the electrode. The coating layer may be formed as a thin and dense layer. It may be formed from a material selected for its high electrical insulation strength. For example, it may be based on formaldehyde resin.

As shown in FIG. 4, the cleaning electrode 40 may include a flat surface 42 that may be arranged adjacent to, and parallel to, the patterned surface 11 of the patterning device 12. However, other geometries may be used. For example, the cleaning electrode 40 may be formed such that it has a tip or a blade edge that is disposed close to the patterned surface 11 of the patterning device 12. This may help to provide the maximum electric field near the patterning device. The radius of curvature of the edge of the blade, for example, may be selected to be approximately one or two times the distance between the electrode and the patterned surface. In a further alternative arrangement, the cleaning electrode may be formed as a mesh or grid adjacent to the patterned surface 11 of the patterning device 12.

The cleaning system depicted in FIG. 4 may be provided in a separate cleaning chamber. In this case, an actuator system may be provided to enable the cleaning electrode 40 to move relative to the patterning device 12 in order to scan across all of the patterned surface 11 of the patterning device 12 in order to remove contaminant particles from the entire surface.

In an embodiment, the cleaning system may be incorporated as part of a lithographic apparatus. In that case, the patterning device 12 may be cleaned while it is supported on the support structure MT used to support the patterning device during a lithography progress. Furthermore, the electrode 40 may be arranged such that cleaning of the patterning device may take place at the same time as the patterning device 12 is being used to pattern a beam of radiation during a lithography process. In an arrangement in which the cleaning system is provided within a lithographic apparatus, it may not be desirable to provide a separate actuator system in order to move the electrode 40 relative to the patterning device 12. Instead, it may be possible to provide the required relative motion using an actuator system provided to move the patterning device 12 relative to a beam of radiation to be patterned during the lithography process.

A cleaning system is provided by an embodiment of the present invention and may be an improvement on the electrostatic cleaning system discussed above. An arrangement of such a cleaning system is depicted in FIG. 2.

The cleaning system of an embodiment of the present invention recognizes that in order to extract particles of the surface of a cleaning device by means of an electrostatic force, it is desirable to apply a charge to the particles to be removed. In an arrangement such as that discussed above, the charge may only be induced in the particles to be removed if the particles and the patterning device itself are sufficiently electrically conductive. Accordingly, for some patterning devices and for some contaminant particles, or combinations thereof, the electrostatic cleaning system discussed above may not be sufficiently effective. Furthermore, the high voltage to be applied to the electrode may mean that the cleaning process has to take place set apart from the remainder of the lithographic apparatus in order to avoid discharge to other parts of the lithographic apparatus. Accordingly, the cleaning system may be provided in an entirely separate apparatus, in part of a handling apparatus for patterning devices or may be provided in a separate chamber within a lithographic apparatus. Accordingly, this may increase the capital cost of a lithographic system significantly and may increase the cost of operation due to the time it takes to transfer a patterning device to the location of the cleaning system and perform the cleaning process.

Embodiments of the present invention recognize that an alternative process for charging the contaminant particles on the patterning device is available. In particular, the beam of radiation that is to be patterned and projected onto the substrate by the lithographic apparatus is used to charge the contaminant particles. This may be particularly appropriate for use in lithographic apparatus using EUV beams of radiation. The beam of radiation, such as an EUV beam of radiation, may charge the contaminant particles on a patterning device by at least three mechanisms. A first mechanism is the photoelectric effect, by which high-energy photons of the beam of radiation eject electrons from the matter of the contaminant particles. As a result, the contaminant particles become positively charged. A second mechanism results from the formation of a plasma. In particular, in a lithographic apparatus, such as one using EUV radiation, a chamber within which the patterning device is illuminated by the beam of radiation may be largely evacuated in order to reduce the absorption of the beam of radiation. However, a relatively low pressure of gas may be retained such that the beam of radiation passing through it forms a plasma. This results in the release of electrons that may be absorbed by the contaminant particles, resulting in those particles becoming negatively charged. A third mechanism also results from the photoelectric effect. Specifically, the photoelectric effect may cause electrons to be ejected from the patterning device and these may be absorbed by the contaminant particles on the patterning device, also causing the particles to become negatively charged.

It should be appreciated, therefore, that while one mechanism may result in the particles becoming positively charged, another mechanism may result in the particles becoming negatively charged. The balance of these contaminant particle charging mechanisms, which will result in the particles becoming overall positively or negatively charged, may depend on the precise operating conditions of the lithographic apparatus. For example, the balance may be affected by the pressure and composition of the gas within the chamber, the wavelengths and intensity of the beam of radiation used, the composition of the contaminant particles themselves, the location of contaminant particles on the patterning device (namely whether the portion of the patterning device with which they are in contact is electrically conducting), the composition of the patterning device, any bias applied to the patterning device, and the duty cycle of the beam of radiation. In particular, the beam of radiation may be pulsed, resulting in a non-stationary plasma within the chamber.

It will be appreciated that the contaminant particle charging mechanisms discussed above relate in particular to the use of electromagnetic beams of radiation. However, an embodiment of the present invention may also be applicable to lithography apparatus using charged particle beams of radiation. In such an arrangement, it will be apparent that the charged particle beam of radiation that is to be patterned by the patterning device will directly provide a charge to the contaminant particles which may then be used to remove the contaminant particles from the patterning device.

As shown in FIG. 2, a cleaning system according to an embodiment of the present invention may include a cleaning electrode 10 that is provided adjacent to the patterned surface 11 of the patterning device 12 and is connected to a voltage supply 13. The cleaning electrode 10 is configured to be immediately adjacent to a region 11a of the surface 11 of the patterning device 12 on which the beam of radiation 15 to be patterned is incident. Therefore, the cleaning electrode 10 is close to the region 11 a in which the beam of radiation generates a charge on the contaminant particles. Accordingly, when the voltage supply 13 establishes an appropriate electric charge at the cleaning electrode 10, the contaminant particles are attracted to the cleaning electrode 10 by an electrostatic force. The voltage supply 13 may establish a voltage difference between the patterning device 12 and the cleaning electrode 10 that results in a net electrostatic force on the contaminant particles towards the cleaning electrode 10. It will be appreciated that the patterning device 12 may be grounded, in which case the voltage supply 13 establishes a voltage difference between the cleaning electrode 10 and ground.

Alternatively, the voltage supply may establish a voltage difference between the patterning device 12 and ground, establishing an electric charge at the patterning device 12. By the appropriate selection of the voltage difference between the patterning device 12 and ground, the contaminant particles charged by the beam of radiation being patterned by the patterning device 12 may be repelled from the patterning device 12 by an electrostatic force. Accordingly, in a variant of an embodiment of the present invention, the cleaning electrode 10 may be omitted and the patterning device may be cleaned purely by electrostatic repulsion of the contaminant particles from the patterned surface 11 of the patterning device 12. It will be appreciated that the cleaning system may be configured such that the contaminant particles are both repelled from the patterning device 12 and attracted to a cleaning electrode 10.

The apparatus may include a voltage supply controller 20 that controls the voltage supply 13. In particular, the voltage supply controller may control the voltage difference established by the voltage supply 13 between the cleaning electrode 10 and the patterning device 12 and/or between the cleaning electrodes 10 and ground and between the patterning device 12 and ground. The voltage supply controller 20 may be configured to provide the appropriate voltage for the operating conditions of the lithographic apparatus in order to take into account the balance between the two mechanisms for charging the contaminant particles discussed above.

For example, a lithographic apparatus may be configured to operate according to a given mode of operation, and/or with some variation, such that it is determined that one or other of the contaminant particle charging mechanisms discussed above will dominate. In that case, the voltage supply controller 20 may be configured such that either a positive or a negative voltage difference between the cleaning electrode 10 and the patterning device 12 and/or between the cleaning electrode 10 and ground and between the patterning device 12 and ground is provided, as appropriate.

Alternatively, the lithographic apparatus may be configured to operate under operating conditions that vary sufficiently that neither mechanism dominates under all contemplated operating conditions. In that case, the voltage supply controller 20 may be configured to determine whether a positive or a negative voltage between the cleaning electrode 10 and the patterning device 12 and/or between the cleaning electrode 10 and ground and between the patterning device 12 and ground will be appropriate for the operating conditions of the lithographic apparatus and control the voltage supply 13 according to provide the desirable voltage difference for the cleaning system to be effective under those operating conditions. For example, the voltage supply controller may be provided with look-up tables that enable the voltage supply controller 20 to determine the appropriate voltage settings for a given set of operating conditions.

As with the arrangement discussed above and depicted in FIG. 4, the cleaning electrode 10 may be at least partially coated with an adhesive such that contaminant particles removed from the patterning device 12 and striking the electrode 10 may be retained on the electrode 10 and thus prevented from returning to the patterning device.

As will be apparent, a potentially significant advantage of a cleaning system arranged in this manner is that the cleaning system may use the radiation system already provided for the operation of the lithographic apparatus rather than requiring the provision of a radiation system specifically for cleaning. Furthermore, the cleaning process may take place at the same time as the operation of the lithographic apparatus, namely at the same time as a beam of radiation is being patterned by the patterning device 12 and is being projected onto a substrate in order to form a device. Accordingly, continual cleaning of the patterning device 12 may be provided and it may be possible to avoid providing separate solely for cleaning the patterning device.

A further potential advantage is that contaminant particles generated during the exposure process may be drawn directly to the cleaning electrode 10, namely may be prevented from ever reaching the patterning device 12. Accordingly, the desire to clean the patterning device 12 may be reduced. Furthermore, the additional capital cost required to provide the cleaning system may be minimized.

A further advantage is that a contaminant particle deposited on part of the patterning device 12 during one exposure may be removed from the patterning device 12 during the next exposure that uses part of the patterning device 12. Accordingly, a defect in a pattern formed on a substrate that may occur as a result of the presence of the contaminant particle on the patterning device 12 may only occur on one part of the substrate on which the pattern is exposed and not on all parts of the substrate on which that part of the pattern of the patterning device is exposed. Accordingly, only one of the many devices that may be formed on a single substrate may be affected by the temporary presence of the contaminant particle on the patterning device 12. Accordingly, the yield of the lithography system overall may be improved.

In a lithographic apparatus, the patterning device 12 may be arranged to move relative to a beam of radiation 15 that is incident on the patterning device. Accordingly, the illumination of the pattern on the patterning device 12 can be scanned, enabling a larger area of pattern to be transferred to a substrate than can be illuminated by a single illumination field. It will be appreciated that in such a lithographic apparatus, as the beam of radiation scans across the surface of the patterning device 12, the region in which the beam of radiation charges contaminant particles also moves. Accordingly, a cleaning system according to an embodiment of the present invention may be configured such that the cleaning electrode 10 remains substantially stationery relative to the beam of radiation 15 such that the cleaning electrode 10 remains immediately adjacent to the region 11a on the surface of the patterning device 12 that is illuminated by the beam of radiation 15. Therefore, the cleaning electrode 10 remains sufficiently close so that it can attract the charged contaminant particles, while not interfering with the beam of radiation that is being patterned by the patterning device 12.

As depicted in FIG. 2, a single cleaning electrode 10 may be provided. However, it will be appreciated that various configurations of cleaning electrodes 10 may be provided. For example, the cleaning electrode may be annular in shape or otherwise be configured such that it surrounds the region 11 a on the surface of the patterning device 12 on which the beam of radiation is incident without interfering with the beam of radiation 15 being patterned by the patterning device 12.

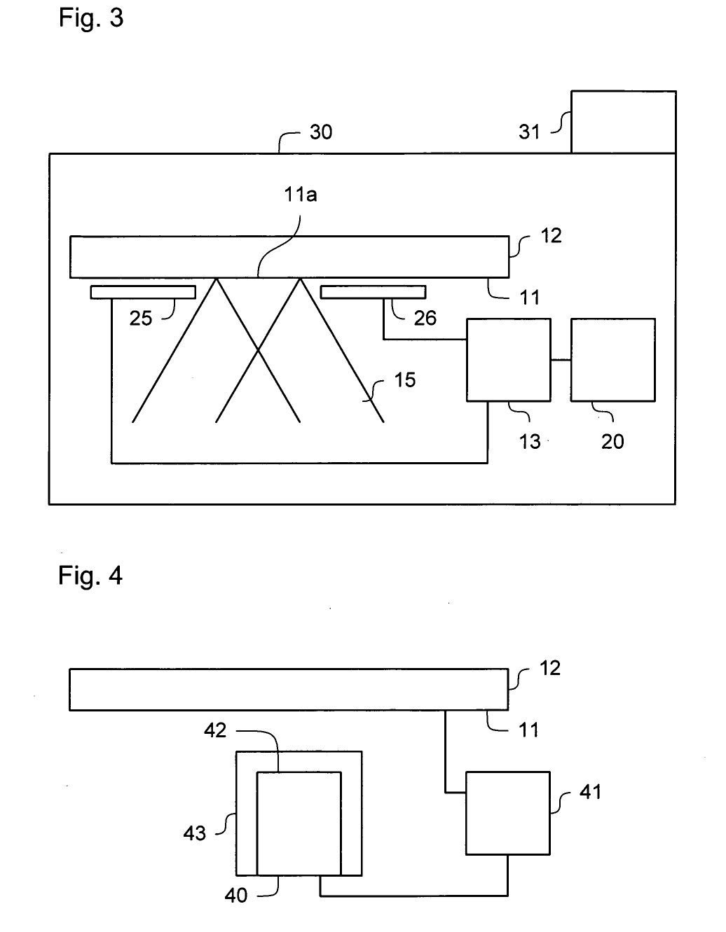

Alternatively, as depicted in FIG. 3, two or more cleaning electrodes 25, 26 may be provided. In such an arrangement, a voltage supply 13 may provide the same voltage to both cleaning electrodes 25, 26. Alternatively, for example, the voltage supply 13 may be configured to provide different voltages to each of the cleaning electrodes 25, 26. For example, the voltage supply 13 may provide a positive voltage to one of the electrodes and a negative voltage to the other of the electrodes such that, regardless of the net charge applied to the contaminant particles, the contaminant particles would be attracted to one or other of the cleaning electrodes 25, 26.

Although, as depicted in FIG. 3, the two or more cleaning electrodes 25, 26 may be on opposite sides of the region 11 a on which the beam of radiation 15 is incident, it will be appreciated that this need not be the case. However, where a positive voltage is to be applied to one electrode, while simultaneously a negative voltage is to be applied to another electrode, the electrodes must be sufficiently separated that there is no electric discharge between them. Furthermore, it may be desirable to have an electrode that entirely surrounds the region 11a on the surface of the patterning device 12 on which the beam of radiation is incident or to provide separate electrodes on opposite sides of the region 11a because, during operation of the lithographic apparatus, the relative movement of the patterning device 12 relative to the beam of radiation will change direction. For example, the scanning of the patterning device may follow a so-called “meander path”, with the result that it moves back and forth relative to the beam of radiation. Accordingly, by arranging electrodes on different sides of the beam of radiation 15, it may be arranged that a cleaning electrode is always located at the advancing side or the receding side, as required.

The voltages applied to the one or more cleaning electrodes 10, 25, 26 may be constant during a cleaning process. For example, the applied voltages may be constant throughout the operation of the lithographic apparatus. However, the voltages may also vary in time. Such an arrangement may be particularly appropriate, for example, if the beam of radiation that is being patterned in the lithographic apparatus is pulsed. In this case, the voltage applied to the at least one cleaning electrode 10, 25, 26 may be pulsed in synchronism with the pulsed beam of radiation.

For example, the voltage may be applied at the same time as the pulses of the beam of radiation or maybe applied between pulses of the beam of radiation. In particular, the voltage may be applied shortly after the pulse of the beam of radiation such that the charged contaminant particles will move from the region 11a on the surface of the patterning device 12 that is illuminated by the beam of radiation 15 to an area adjacent a cleaning electrode 10. In an alternative arrangement, the cleaning electrode 10 may be positively biased during a pulse of the beam of radiation in order to encourage the release of electrons from contaminant particles as a result of the photoelectric effect during the pulse of the beam of radiation. However, subsequently, it may be desirable to provide a negative bias to the cleaning electrode in order to attract the particles charged by the photoelectric effect to the electrode and to encourage the charging of contaminant particles by the alternative mechanisms discussed above. Subsequently, it may be desirable to again switch the bias to the cleaning electrode 10 in order to attract the contaminant particles that have been negatively charged to the electrode 10. It will be appreciated that corresponding considerations may be given to the bias applied to the patterning device 12.

Accordingly, an arrangement having a single cleaning electrode, the voltage supply 13 may provide a positive voltage at one point during the duty cycle of the beam of radiation and a negative voltage at another part of the duty cycle. For example, if one mechanism or the other for generating charge in the contaminant particles dominates at different times in the duty cycle, a positive voltage may be provided either during the pulses of the beam of radiation or during the periods between the pulses of the beams of radiation and a negative voltage may be provided during the remainder of the duty cycle. A similar arrangement may be used in a cleaning system having more than one cleaning electrode 25, 26.

It will be appreciated if the voltages applied to the cleaning electrode and/or the patterning device switch during the duty cycle of the beam of radiation, there is an inherent risk that contaminant particles may be driven towards the patterning device instead of removed from it. Accordingly, as discussed above, the cleaning electrode 10 may be coated with an adhesive in order to retain contaminant particles.

The cleaning systems disclosed herein may, as depicted for example in FIG. 2, include a gas outlet 16 that may be connected to a gas supply 17 in order to provide a flow of gas 18 to the patterning device 12. The flow of gas 18 may be used to transport away from the patterning device 12 contaminant particles that have been removed from the patterning device 12 by the cleaning system. Alternatively, a suction pipe (not shown) may generate a gas flow directed away from the cleaning area. Accordingly, the risk of contaminant particles returning to the patterning device may be reduced.

As depicted in FIGS. 2 and 3, the patterning of the beam of radiation 15 using the patterning device 12 and, accordingly, the performance of the cleaning process using the at least one cleaning electrode 10, 25, 26 may take place within at least one chamber 30 that may be evacuated or at least reduced to a pressure significantly below the environment surrounding the lithographic apparatus in order to reduce the absorption of the beam of radiation 15. Accordingly, the lithographic apparatus may include a gas control system 31 that is arranged to control the pressure of the gas within the chamber 30.

The gas control system 31 may also control the composition of the gas remaining within the chamber 30. For example, the gas control system may reduce the pressure of a gas within the chamber 30 to approximately 3 N/m². Furthermore, the gas control system 31 may be configured such that the gas remaining within the chamber 30 substantially comprises an inert gas.

The gas control system 31 may be configured to provide information relating to the operating conditions of the lithographic apparatus, such as the gas pressure within the chamber 30 and the composition of the gas within the chamber 30, to the voltage supply controller 20 in order that the voltage supply controller 20 may control the voltage supply 13 to provide the appropriate voltage difference for the cleaning process as discussed above.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that embodiments of the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that embodiments of the invention may be practiced otherwise than as described. For example, embodiments of the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to embodiments of the invention as described without departing from the scope of the claims set out below.

1. A lithographic apparatus comprising:
an illumination system configured to condition a beam of radiation;
a support structure configured to support a patterning device, the patterning device being configured to impart a pattern to the beam of radiation;
a projection system configured to project the beam of radiation patterned by the patterning device onto a substrate;
the apparatus being configured to pass the beam of radiation through gas adjacent the patterning a plasma; and
a patterning device cleaning system configured to provide an electrostatic force to contaminant particles that are on the patterning device and that are electrically charged by the electrons that are liberated during the formation of the plasma generated by the beam of radiation, in order to remove the contaminant particles from the patterning device.

2. (canceled)

3. (canceled)

4. The lithographic apparatus according to claim 1, wherein the patterning device cleaning system comprises a voltage supply configured to be connected to the patterning device when the patterning device is supported by the support structure and to provide an electric charge to the patterning device such that contaminant particles electrically charged by the beam of radiation are electrostatically repelled from the patterning device.

5. The lithographic apparatus according to claim 4, wherein the voltage supply is configured to provide a pulsed voltage difference between the patterning device and ground during operation of the lithographic apparatus, the pulses of voltage difference being synchronized to pulses of the beam of radiation incident on the patterning device.

6. The lithographic apparatus according to claim 4, wherein the voltage supply is configured to provide a constant voltage difference between the patterning device and ground during operation of the lithographic apparatus.

7. The lithographic apparatus according to claim 5, wherein the voltage supply is configured to provide a positive and/or a negative voltage difference between the patterning device and ground.

8. (canceled)

9. The lithographic apparatus according to claim 1, wherein the patterning device cleaning system comprises a cleaning electrode and a voltage supply connected to the cleaning electrode, the voltage supply configured to provide an electric charge to the cleaning electrode such that contaminant particles electrically charged by the beam of radiation are electrostatically attracted to the cleaning electrode.

10. The lithographic apparatus according to claim 9, wherein the cleaning electrode is configured such that, during operation of the lithographic apparatus, the cleaning electrode is adjacent the patterning device in a location immediately adjacent to a region on which the beam of radiation is incident on the patterning device.

11. The lithographic apparatus according to claim 10, configured such that, during operation of the lithographic apparatus, the patterning device is moved relative to the beam of radiation such that the beam of radiation is incident on different regions of the patterning device, and wherein the cleaning electrode is configured such that during the movement of the patterning device relative to the beam of radiation, the cleaning electrode is substantially stationary relative to the beam of radiation such that it remains immediately adjacent to the region on which the beam of radiation is incident.

12. The lithographic apparatus according to claim 9, wherein the cleaning electrode is at least partially coated with an adhesive, the adhesive being configured such that contaminant particles attracted to the cleaning electrode adhere to the adhesive.

13. The lithographic apparatus according to claim 9, wherein the voltage supply is configured to provide a pulsed voltage difference between the cleaning electrode and the patterning device and/or ground during operation of the lithographic apparatus, the pulses of voltage difference being synchronized to pulses of the beam of radiation incident on the patterning device.

14. The lithographic apparatus according to claim 9, wherein the voltage supply is configured to provide a constant voltage difference between the cleaning electrode and the patterning device and/or ground during operation of the lithographic apparatus.

15. The lithographic apparatus according to claim 13, wherein the voltage supply is configured to provide a positive and/or a negative voltage difference between the cleaning electrode and the patterning device and/or ground.

16. (canceled)

17. The lithographic apparatus according to claim 9, further comprising a further cleaning electrode configured such that, during operation of the lithographic apparatus, the further cleaning electrode is adjacent the patterning device in a location immediately adjacent to a region on which the beam of radiation is incident on the patterning device, wherein the voltage supply is configured to provide a voltage difference between the patterning device and the further cleaning electrode.

18. (canceled)

19. (canceled)

20. The lithographic apparatus according to claim 9, further comprising a chamber configured to contain the patterning device and the cleaning electrode, and a gas control system configured to reduce a pressure of gas within the chamber below a pressure of an environment surrounding the lithographic apparatus.

21. The lithographic apparatus according to claim 20, wherein the gas control system is configured to reduce the pressure of gas within the chamber to approximately 3 N/m².

22. The lithographic apparatus according to claim 21, wherein the gas control system is configured to provide an inert gas to the chamber.

23. The lithographic apparatus according to claim 1, further comprising a gas outlet configured to be connected to a gas supply and to provide a flow of gas to the patterning device in order to transport away from the patterning device contaminant particles removed from the patterning device by the patterning device cleaning system.

24. (canceled)

25. (canceled)

26. A device manufacturing method, comprising:
patterning a beam of radiation using a patterning device;
projecting the beam of radiation patterned by the patterning device onto a substrate;
passing said beam of radiation through gas adjacent to the patterning device to generate a plasma; and
removing contaminant particles from the patterning device by applying an electrostatic force to the contaminant particles that have been electrically charged by electrons that are liberated during the formation of the plasma generated by the beam of radiation.

27-34. (canceled)
